(19) United States
(12) Patent Application Publication
(10) Pub. No.: US 2008/0126108 A1
(43) Pub. Date: May 29, 2008

(54) System and method for implementing a meteorological network for improved atmospheric modeling

(76) Inventor: C. Reed Hodgin, Westminster, CO (US)

Correspondence Address: LAW OFFICE OF ROD D. BAKER, 707 STATE HIGHWAY 333, SUITE B, TIJERAS, NM, 87059-7382, US

(21) Appl. No.: 11/542,464

(22) Filed: Oct. 3, 2006

Related U.S. Application Data
(60) Provisional application No. 60/725,382, filed on Oct. 11, 2005.

(51) Int. Cl. G06Q 10/00

(52) U.S. Cl. 705/1

(57) ABSTRACT

A system and method for designing and implementing a meteorological network to provide input data to atmospheric dispersion models for predicting the potential impact of hazardous material release into an environment. This method and system may be used for both initial design and for continuous improvement to the network, and may combine heuristic and statistical based data sets to achieve improved atmospheric dispersion modeling results. A method for improving an existing or partial meteorological network is also disclosed.

### PARENT CASE INFORMATION

This application claims the priority of provisional application 60/725,382, filed on Oct. 11, 2005, the entirety of which is incorporated herein by reference.

### STATEMENT REGARDING FEDERALLY SPONSORED RESEARCH

This invention is made under contract DAMD17-00-C-0010 with the United States Department of Defense. The Federal Government has certain rights in this invention.

### BACKGROUND OF THE INVENTION

1. Field of the Invention (Technical Field) This invention relates to the field of atmospheric modeling; more particularly, the invention relates to a method for designing and implementing a meteorological network to predict the potential impact of hazardous material release into an environment. This invention may be used for both initial design and for continuous improvement to the network.

2. Background Art

Tools and equipment for modeling atmospheric data have been increasingly used by both public and private entities to predict the spread of materials released into the atmosphere. Equipment may include weather-related devices such as wind direction sensors, wind-speed sensors, or other meteorological and environmental sensors. An atmospheric dispersion modeling system, such as the Hazard Prediction and Assessment Capability (HPAC) system, may also be used to predict the impact of a release of materials into the environment. An atmospheric dispersion modeling system relies on data obtained by specific equipment, and an established methodology for integrating the data acquired by that equipment. This methodology allows a person or group of persons to predict the release of a hazardous material, determine the area of exposure and make critical decisions to avoid further risks. The sensing equipment used with an atmospheric dispersion modeling system must be oriented in a way to maximize the accuracy of the data. Previously used equipment and methodology is described generally in U.S. Environmental Protection Agency Report No. EPA-450/4-87-013 (See www.epa.gov/scram001/tt24.htm#guidance); World Meteorological Organization Guide to Meteorological Instruments and Methods of Observation, No. 8, 5^{th} edition, Geneva Switzerland; and Air Monitoring Survey Design, Kenneth E. Noll and Terry L. Miller, Ann Arbor Science Publishers, Inc., 1977 (Library of Congress Catalog Card No. 76-22233), which are incorporated herein by reference.

Previous systems for implementing a network of meteorological devices contain several disadvantages. One disadvantage is that these previous systems often rely solely on existing equipment to provide meteorological data. One problem is that current meteorological systems are used primarily for collecting data on large or synoptic scales for reporting to aviation centers and weather forecasting agencies. As a result, there is no local scale data collected, and thus the data is often not representative enough to allow for effective decision-making or analysis of the network. Other networks collect only limited sets of data, either with respect to geographic space or time, and do not allow for both diagnostic and prognostic modeling. For example, current systems use only real-time data from meteorological stations that are not positioned relative to the area of interest. Other systems may be located in close proximity to meteorological stations, but have inadequate monitoring in the areas proximate to the area of interest. These prior art systems also often rely on heuristic rules and other modeling assumptions. These prior art systems are thus over-dependent on non-statistical information.

The previous systems are also limited in how they may be measured and optimized. It is frequent that data collected from these earlier systems is not presented in a format where it may be compared to historical data or to modeling systems proposed by the user. This prevents the user from tracking system performance over time and characterizing key changes in the atmospheric data (such as diurnal or seasonal changes). It also limits' how the user is able to examine hypothetical situations, such as degradation of the network, or to predict possible failures in the system. Another disadvantage is that the system is designed without consideration of actual constraints on the network or the users. These constraints may include equipment location, experimental control, lack of resources and time restrictions. Thus the prior art systems and methods often do not allow the user to combine measurable quantities with model-derived data to improve performance criteria. These systems are also limited in that they are designed only for short-term installations, or are not flexible enough to be modified for any other application than the facility for which they were designed.

The method and system of the present invention may be incorporated with a process for hazard-based decision making, such as the one disclosed in U.S. patent application Ser. No. 11/416,355 (“the '355 application”), the entirety of which is incorporated herein by reference. The necessity for design and implementation of a reliable meteorological network that allows for both diagnostic and prognostic modeling is even greater when incorporated with an Emergency Management Preparedness system as contemplated in the '355 application.

These and other problems exist in the current technology associated with designing and implementing a meteorological network for atmospheric modeling. Thus, a need arises in providing a method that allows for both synoptic and local measurement, allows for diagnostic and prognostic analysis, optimizes the number and placement of sensing devices, allows for implementation across a wide spectrum of different types of facilities, may be designed or modified to meet a variety of different types of constraints, and that otherwise eliminates the problems with prior art systems as highlighted above.

### BRIEF DESCRIPTION OF THE DRAWINGS

The accompanying drawings, which are incorporated into and form a part of the specification, illustrate several aspects of the present invention and, together with the description, serve to explain the principles of the invention. The drawings are only for the purpose of illustrating a preferred embodiment of the invention and are not to be construed as limiting the invention. In the drawings:

FIG. 1 is a flowchart diagram of the method in a preferred embodiment;

FIG. 2 is an exemplary project scope data table useable in a preferred embodiment;

FIG. 3 is a display of a representative example map and recommended output contour for placement of additional sensors in a preferred embodiment; and

FIG. 4 is an example of a factor-analysis and influence table useable in a preferred embodiment.

### DESCRIPTION OF THE PREFERRED EMBODIMENTS

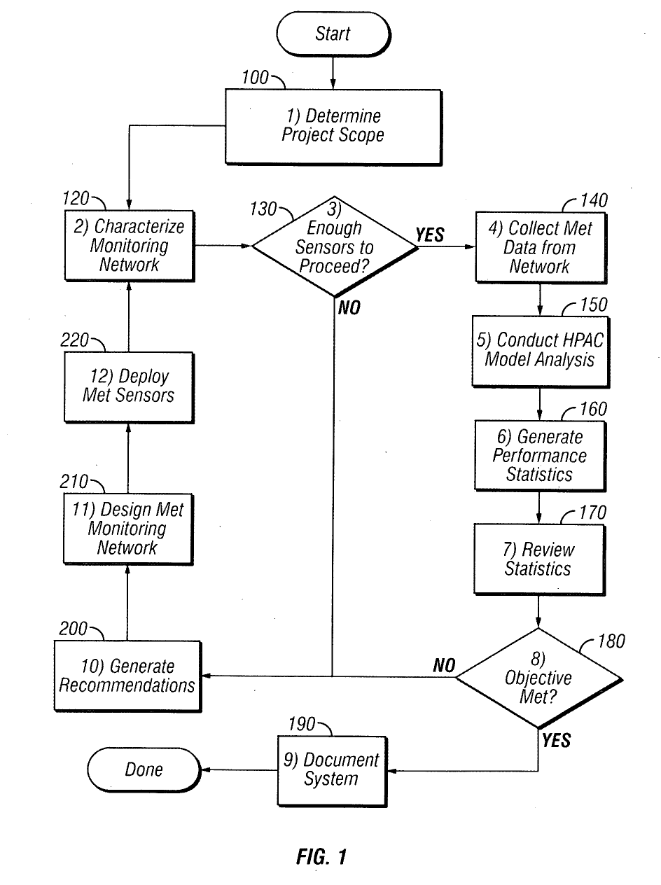

A preferred embodiment of the present invention is illustrated in FIGS. 1-4 and the following written description. It is to be expressly understood that the descriptive embodiment is provided herein for explanatory purposes only and is not meant to unduly limit the claimed inventions. Other embodiments of the present invention are considered to be within the scope of the claimed inventions, including not only those embodiments that would be within the scope of one skilled in the art, but also as encompassed in technology developed in the future. Although airborne hazards are often used as an example of a hazard being used with this invention, these are discussed primarily for the purposes of understanding the system and method application. It is to be expressly understood that other atmospheric events and hazards are contemplated for use with the present invention as well.

In a preferred embodiment of the invention, a method and system is disclosed for designing and implementing a site-specific meteorological network to provide improved monitoring and assessment capabilities. This method may be used, for example, with an atmospheric dispersion modeling system, such as the Hazard Prediction and Assessment Capability (HPAC) system, for modeling the results of a hazardous material release into the environment. The system and method of the invention combine objective, statistically based data sets with more traditional heuristic data sets to provide the optimal number and placement of network sensing devices. Sensing devices may include, but are not limited to wind direction sensors, wind-speed sensors, or other meteorological or environmental sensors. The method may be used singularly, as in a single iteration, or repeatedly, with multiple iterations, to further refine the network performance. The method may also be used to perform either diagnostic or prognostic analysis of the network.

Referring in detail to FIG. 1, the method in its varying embodiments may be comprised of various steps (100 through 220) including those steps included in the flowchart diagram of FIG. 1. In FIG. 1, the first step in the method is labeled Step 1 (100), whereby a user determines a set of parameters that will control the methodology and assist in the design process. This Step 1 (100) is titled the Project Scope, and is comprised of design control criteria and other information necessary to the network design process. In this preferred embodiment, one of the criteria considered during Step 1 (100) is the result, or Support Need, which requires the network to be optimized. In one embodiment for use with an atmospheric dispersion modeling system, these Support Needs may include field monitoring support, building re-entry support, contingency or hazard assessment planning, post-accident analyses, and crisis support termination.

Another criterion of Step 1 (100) in a preferred embodiment is the defining of the project objective. Project objectives may include improvement of the accuracy or reliability of the meteorological network, optimization of the whole or part of the network, increased measurement throughout the network, characterizing changes in the network, or performing hypothetical experimentation or analysis on the network.

Project Needs are also a consideration of Step 1 (100). Project Needs may include, but are not limited to, the duration of the system, the ability to forecast or perform historical analyses, and the urgency of completing and documenting the system. For example, a particular Project Need may be to implement the meteorological network prior to a scheduled event. Other types of Project Needs may be considered which may affect the project objective.

Another criterion of Step 1 (100) is the analysis of Modeling Issues. Modeling Issues may include the existence of available meteorological data. The user may determine that existing data is acceptable for use in the method and incorporate that data with the system. Another Modeling Issue is defining the parameter to be used in designing the system. In a preferred embodiment, a single parameter is selected for a particular iteration, to isolate any variation to that single parameter. In alternate embodiments, more than one parameter may be selected for a single iteration. Modeling Parameters may include maximum concentration, maximum deposition, location of maximum concentration or deposition, area above concentration threshold, area above deposition threshold, plume timing, wind fields, or parcel trajectories. One skilled in the art will realize that other parameters may be used as well without departing from the present inventive concepts disclosed herein.

Also in Step 1 (100), the user selects whether to use a diagnostic model, which will not forecast the atmospheric state given historical data, or a prognostic model, which may predict future states based off one or more past states. In either model the user also selects the Time Window, or specific time and date parameters for measurement and collection of data, and Area of Interest, or geographic area which requires consideration of meteorological monitoring and analysis. Once these criteria have been selected, the user may estimate the initial acceptance criterion. The initial acceptance criterion is based in part on the chosen statistical limits or ranges, and may be modified as additional iterations produce more accurate statistical limits. In a preferred embodiment, the initial acceptance criteria includes a threshold percentage (e.g., 5%), which thereby allows the statistics to vary by this amount without causing further modification to the initial or follow-on acceptance criteria.

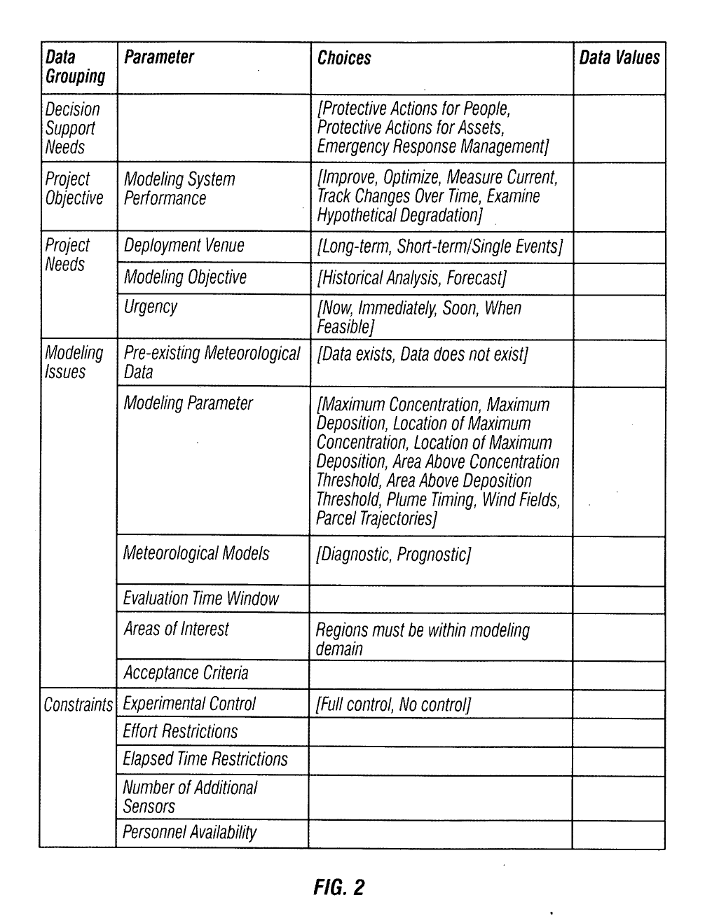

The final task in Step 1 (100) is evaluating system constraints. In a preferred embodiment some of the possible constraints are listed in the table of FIG. 2. The users should consider the amount of control they have over the network, and in particular the number and location of sensing devices available, before proceeding to Step 2 (120). For example, an Area of Interest that is adjacent to a large body of water may have physical constraints on the location of sensing devices. Therefore, system constraints may play a large role in determining the reliability and effectiveness of the meteorological network at an early stage in the design process.

As shown in FIG. 2, the foregoing criteria of Step 1 are listed in table format. In a preferred embodiment, these criteria may be predetermined and represented to a user via a computer operating system and graphical user interface. In an alternate embodiment, the user may be provided with a non-electronic display such as a checklist or other visual form for presenting the user with these criteria. Combinations of and variations to these two display embodiments are also contemplated.

Step 2 (120) is a step for the user to Characterize the Network, which is defined to mean selecting identifying or descriptive terms for the particular network iteration. In a preferred embodiment, the step of Characterizing the Network may include selecting individual unique identifiers for network versions, time and date fields, descriptions of the geographical area(s) encompassed, individual station information, reporting levels, and images of the Area of Interest showing sensing device locations. This information allows the user to track iterations and modifications through each process loop. Once this network has been defined, the user may create baseline data, either from existing meteorological stations or from model-based information, to provide the user with an initial screening data set. As the network design and implementation continues, the user may compare later acquired data to the baseline data and eliminate anomalies outside the performance criteria.

In Step 3 (130) the user determines whether there are a sufficient number of sensing devices to proceed with the network implementation. In a preferred embodiment, other areas besides the Area of Interest are considered when performing this step. Areas that could influence the Area of Interest are also taken into account, including the Immediate Response Area and the Full Domain. The Immediate Response Area is bounded by the maximum distance the surface winds could traverse within a pre-defined response time. The Full Domain is bounded by the space that includes features that might affect airflow into the Area of Interest during the Time Window selected in Step 1 (100). These areas may be established initially during Step 3 (130) and redefined as additional meteorological data is collected.

In a preferred embodiment the method accounts for existing meteorological network equipment such as sensing devices. If there are sufficient sensing devices in the Area of Interest, the Immediate Response Area, and the Full Domain, then the user proceeds to Step 4 (140). If there are not enough sensing devices, the user instead proceeds as shown in FIG. 1 to Step 10 (200). If the user proceeds to Step 4 (140), the user collects meteorological data from the network via the existing sensing devices. In a preferred embodiment, this Step 4 (140) may be automated. Processes for automating this Step 4 (140) would be understood by a computer programmer of ordinary skill in the art. In alternate embodiments the data may be collected and recorded manually. Combinations of manual and automated collection and recordation are also contemplated for use with the present invention.

Once data has been collected from the network, the user conducts an analysis of an atmospheric dispersion modeling system to generate Performance Statistics in Step 5 (150). The project objectives defined in Step 1 (100) are the baseline for comparing the results obtained from the meteorological network, and for determining whether performance is sufficient to meet the Project Needs. Performance Statistics may include for example a comparison, as by a ratio, between base line data and obtained data, with acceptable ratio ranges defining acceptable performance. In a preferred embodiment, the process by which data is analyzed in Step 5 (150) may be automated to reduce the time needed for implementing changes in the next iteration. The objective of optimization is illustrated as an example of how this potential project objective influences the analysis under Step 5 (150). Under this objective of optimization, iterations are repeated, each with selective removal of a particular station input. The iterations are repeated in relationship to the number of stations, n, by n(n−1)+1, in order to cover all permutations. In a preferred embodiment, to best characterize atmospheric conditions, a user should sample no fewer than 20 times while each station is removed. This effectively provides the user with a data set that allows him or her to realize the optimal network station configuration.

In Step 6 (160) the user executes routines to gather model Performance Statistics. Performance Statistics is defined to include the network version identifier, the metrics examined, the statistics used, the evaluation period, the raw data scores, the operational scores, and the final performance scores as a function of the sensing device associated with those scores. In a preferred embodiment, the Performance Statistics may be displayed over time in various charts and tables to allow the user to visualize the trends and make reasoned decisions. One skilled in the art would acknowledge that a variety of different routines, both manual and automated, are available to collect model Performance Statistics. The Performance Statistics often depend on selections made during Step 1 (100), including the Project Scope. The user may also make comparisons of different statistical data sets in order to make pairings necessary to complete the design and implementation process. For example, the maximum concentration parameter and the location of maximum concentration parameter may be paired to determine which areas are the most affected by a particular model and thereby create a Performance Statistical Data Set. Performance Statistics and Performance Statistical Data Sets may be collected and recorded in a computer operating system, and archived and recalled for future comparisons as needed.

In Step 7 (170) the user reviews the statistics generated so far, and eliminates any anomalies, variations or problems. This Step 7 (170) may be used to perform a check of the integrity of the input data, the modeling systems, and the statistical routines. It may also be used to make sure values are within the ranges expected by the user, or to correct assumptions or recommendations made previously during the design process.

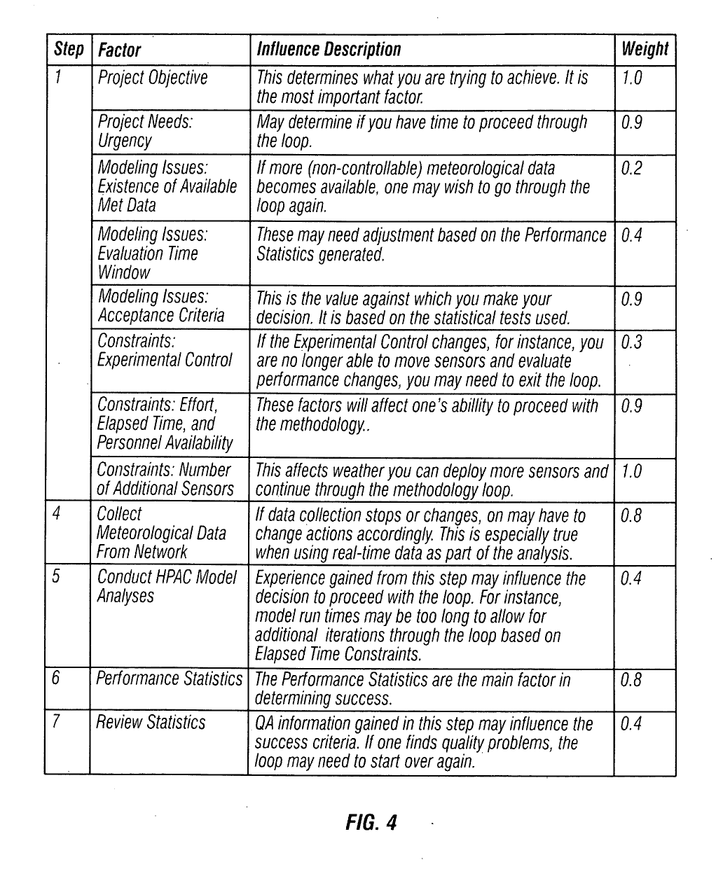

In Step 8 (180) the user again is presented with alternate paths. If the user determines that the project objectives have been met, the user may continue to Step 9 (190) and document the system parameters and Performance Statistic Data Sets. In a preferred embodiment of the invention, some of the potential factors that a user may consider in making this determination are listed in the table of FIG. 4. In this preferred embodiment the factors are listed by the steps of the method (100 through 220) and are given a weighting value to emphasize their importance to the overall process.

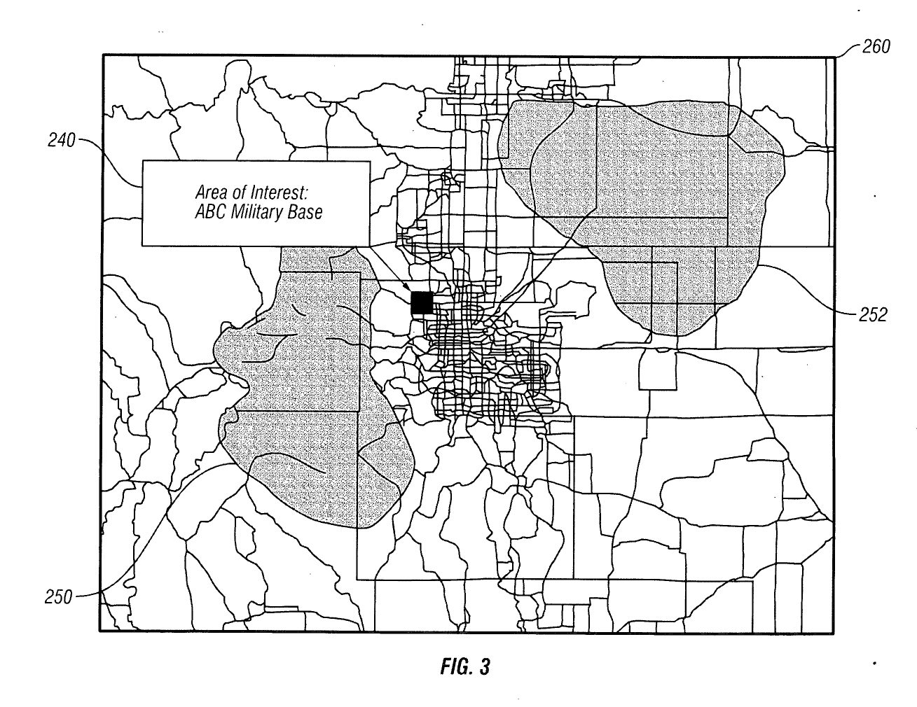

If the user determines that the objectives have not been met, then the user continues to Step 10 (200). In Step 10 (200) the user generates recommendations for modifying the number or location of the sensing devices. One example of how this may be accomplished is provided in FIG. 3, which shows a display including an Area of Interest (240) within the Full Domain (260). In this diagram the Immediate Response Area has not yet been defined. Two areas are represented as contours (250, 252) on the display of FIG. 3 where additional sensing devices are recommended as being necessary to the Project Scope. These contours (250, 252) may be calculated either by the statistical data, or the heuristic information, or a combination of both. Further iterations may assist in defining the areas where additional numbers or locations of sensing devices are needed more distinctly. It is also during Step 10 (200) that other recommendations may be made, including but not limited to placement of different types of sensing devices, accounting for complex terrain, expanding the Area of Interest, Immediate Response Area or the Full Domain, or changing the location of current sensing devices. In the preferred embodiment, the user may also make recommendations by plotting the function of individual objectives and parameters over a specific Area of Interest or a specific Time Window. This method is referred to as Adaptive Targeted Observation, and may be used for either prognostic system forecasting or for purely diagnostic systems.

In Step 11 (210) the user evaluates the locations and other recommendations generated in Step 10 (200). The user may consider factors including terrain, power requirements, line-of-sight limitations, obstructions, access and other constraints on the specific locations. Once the initial numbers and locations for sensing devices have been selected, the user may deploy the sensing devices to each additional location selected. In Step 12 (220) the sensing devices are deployed to the precise locations determined in Step 11 (210). The user then proceeds to Step 2 (120) and begins the process again. In a preferred embodiment, multiple iterations of this process loop may be performed to achieve the project objectives. The factors listed in FIG. 4 are examples of the analyses in a preferred embodiment to determine when to quit the analysis loop and document the final system.

In an alternative embodiment, the user may incorporate tracer-based information into the system to further improve the accuracy of the Performance Statistics and Performance Statistical Data Sets. Each step within the system and method may be more or less automated to accomplish the objectives of the invention. It is contemplated that other embodiments not departing from the spirit of the invention may be achieved, such as combinations of automated and manual processes and sub-processes.

In another alternative embodiment, this method and system may be used to design and situate a monitoring system for sensing substances other than typical for meteorological networks. For example, this method may be used to design a monitoring system to detect other substances, in solid, liquid, gas or vapor form, such as sulfur dioxide or biohazard material. Other materials are contemplated with this alternative embodiment.

In a preferred embodiment this method may be integrated with a computer operating system, with means to track the Performance Statistic criteria through electronic databases and spreadsheets. One skilled in the art would acknowledge the different operator interface means available for displaying this type of information to the user. In this embodiment, the user will be able to view and or manipulate large amounts of data, both statistical and model-based, to enhance the efficiency of the method disclosed herein.

As will be understood by those familiar with the art, the present invention may be embodied in other specific forms without departing from the spirit or essential characteristics thereof. For example, the present invention is not limited in the number or location of sensing devices integrated with the system, or the number or location of facilities impacted by the system. The present invention is also not limited in the geographic area that may be represented in the system. Accordingly, the disclosure of the preferred embodiment of the invention is intended to be illustrative, but not limiting, of the scope of the invention which is set forth in the following claims.

What is claimed is:

1. A method for creating an airborne substance monitoring network comprising the following steps:
A. determining the Project Scope;
B. generating recommendations for the number and location of sensing devices;
C. evaluating the recommendations to determine the number and location of sensing devices;
D. deploying sensing devices to the determined number and location of sensing devices;
E. collecting data from the determined number and location of sensing devices;
F. performing analysis of the data collected;
G. generating Performance Statistics;
H. compiling Performance Statistical Data Sets;
I. reviewing the Project Scope, Performance Statistics and Performance
Statistical Data Sets; and
J. documenting the airborne substance monitoring network.

2. The method of claim 1 wherein step A is further comprised of defining Support Needs.

3. The method of claim 1 wherein step A is further comprised of defining Project Needs.

4. The method of claim 1 wherein step A is further comprised of analyzing Modeling Issues.

5. The method of claim 1 wherein step A is further comprised of accounting for system constraints.

6. The method of claim 1 wherein the airborne substance monitoring network is designed for performing diagnostic analysis.

7. The method of claim 1 wherein the airborne substance monitoring network is designed for performing prognostic analysis.

8. The method of claim 1 wherein the airborne substance monitoring network incorporates the use of existing sensing devices.

9. The method of claim 1 wherein steps B through I are repeated at least once to further optimize the airborne substance monitoring network.

10. The method of claim 1 wherein step 1 further comprises the use of weighting factors to determine whether to repeat steps of the method to optimize the airborne substance monitoring network.

11. A method for improving an airborne substance monitoring network comprising the following steps:
A. determining the Project Scope;
B. characterizing the current monitoring network;
C. determining the status of the sensing devices associated with the current monitoring network;
D. generating recommendations for the number and location of additional sensing devices;
E. evaluating the recommendations to determine the number and location of additional sensing devices;
F. deploying sensing devices to the determined number and location of additional sensing devices;
G. recharacterizing the current monitoring network;
H. evaluating the initial number and location of the sensing devices associated with the current monitoring network and the additional sensing devices in the current monitoring network;
I. collecting data from the sensing devices associated with the current monitoring network and the determined number and location of additional sensing devices;
J. performing analysis of the data collected;
K. generating Performance Statistics;
L. compiling Performance Statistical Data Sets;
M. reviewing the Project Scope, Performance Statistics and Performance
Statistical Data Sets; and
N. documenting the airborne substance monitoring network.

12. The method of claim 11 wherein step A is further comprised of defining Support Needs.

13. The method of claim 11 wherein step A is further comprised of defining Project Needs.

14. The method of claim 11 wherein step A is further comprised of analyzing Modeling Issues.

15. The method of claim 11 wherein step A is further comprised of accounting for system constraints.

16. The method of claim 11 wherein the airborne substance monitoring network is designed for performing diagnostic analysis.

17. The method of claim 11 wherein the airborne substance monitoring network is designed for performing prognostic analysis.

18. The method of claim 11 wherein the airborne substance monitoring network incorporates the use of existing sensing devices.

19. The method of claim 11 wherein steps D through M are repeated at least once to further optimize the airborne substance monitoring network.

20. The method of claim 11 wherein step M further comprises the use of weighting factors to determine whether to repeat steps of the method to optimize the airborne substance monitoring network.
